(19) United States
(12) Patent Application Publication
(10) Pub. No.: US 2018/0189696 A1
(43) Pub. Date: Jul. 5, 2018

(54) SYSTEM AND METHOD FOR MEASURING AND MONITORING INNOVATION INTELLIGENCE

(71) Applicants: Mashallah Torabi, Tehran (IR); Hossein Dargahi, Tehran (IR); Reza Safdari, Tehran (IR)

(72) Inventors: Mashallah Torabi, Tehran (IR); Hossein Dargahi, Tehran (IR); Reza Safdari, Tehran (IR)

(21) Appl. No.: 15/911,416

(22) Filed: Mar. 5, 2018

(51) Int. Cl. G06Q 10/06; G06F 17/30

(52) U.S. Cl. CPC G06Q 10/0633; G06F 17/30321; G06F 17/30598; G06F 17/30592

(57) ABSTRACT

The embodiments herein provide a system and method for measuring and monitoring innovation intelligence of an enterprise/organization. The system provides a meta-model of innovation classifications that allows organizations to measure and monitor their innovation intelligence in qualitative and quantitative manner. In this meta-model, data related to the innovations is retrieved and aggregated from the users. Aggregated data is classified into various indexes. Momentary insight for organization's power on unique assets is achieved by retrieving information in database and analyzing it. Questionnaires are presented to users for gathering further information. Indexes are modified based on results of questionnaires. Retrieved data is analyzed and innovation quotient for organization is computed. Innovation quotient is presented to users based on various evaluation criteria selected by user using dashboard. Each criterion is a measurable index measured by sum of data or other methods. Dashboard represents prepared data in various graphical forms as per user requirement.

### BACKGROUND

### Technical Field

The embodiments herein are generally related to a field of organizational innovations. The embodiments herein are particularly related to systems and methods for assessing innovation capability of an enterprise. The embodiments herein are more particularly related to a system and method for measuring and monitoring innovation intelligence of an enterprise in a qualitative and quantitative manner.

### Description of the Related Art

Business organizations in recent times continually adapt to changing market pressures to ensure customer satisfaction in a way that creates growth for an organization/business. In order to succeed, the organizations strive to search for opportunities that help in sustainable growth. Innovation for organizations includes any business change that results in creating new values.

Development of innovation programs for moving further in the field of knowledge and appropriate focus on competitive advantage is a priority in organizations as well as in academic and commercial institutions. In today's competitive world, innovation in business model is inevitable for effective entry of organizations and knowledge-based institutions in international arenas.

However, a mere attention to the number of innovations is not a reliable index for measurement of innovation performance among different industries. Therefore, leading institutions attempt to provide more complete image of the current status of organization by measuring an innovation potential. The studies conducted in this area denote that innovation is not product of just the individual work, but is a product of a collection of effective factors including teamwork, process, and appropriate utilization of technologies. Thus, designing a tool which allows an investigation of current innovation status in every organization, group, or individual, gives the opportunity to analyze the strengths and a suitable path for mobilizing resources is necessary.

Hence, there is a need for a system and method for measuring and monitoring innovation intelligence of an enterprise in a qualitative and quantitative manner. There is also a need for a system and method to provide a comprehensive map of minor and major indexes and relationship among the indexes for determining an innovation intelligence level of organization. Further, there is a need for a system and method to provide a dashboard to the organization for monitoring and accessing current innovation intelligence status.

The above mentioned shortcomings, disadvantages and problems are addressed herein and which will be understood by reading and studying the following specification.

### OBJECTS OF THE EMBODIMENTS

The primary object of the embodiments herein is to provide a system and method for measuring and monitoring an innovation intelligence of an enterprise in a qualitative and quantitative manner.

Another object of the embodiments herein is to provide a system and method to provide a comprehensive map of minor and major indexes and a relationship among the indexes for determining the innovation intelligence level of an organization.

Yet another object of the embodiments herein is to provide a system and method to provide a dashboard to the organization for monitoring and accessing a current innovation intelligence status of an organization.

Yet another object of the embodiments herein is to provide a system and method to help the organizations in enhancing a brand status in a balanced manner, a knowledge coding, an internationalization of service and product, a development of practiced innovation activities, a plurality of monitoring factors affecting motivation of staff/employees, cultural values strengthening an innovation and management of challenges.

Yet another object of the embodiments herein is to provide a system and method to further help the organizations in calculating an organizational status change, a classification of innovations, an improvement of overall performances of financial value creation and a basic key in organizational capabilities.

Yet another object of the embodiments herein is to provide a system and method to help the organizations to identify the best innovation performances, to accordingly develop a new measurement criteria to promote other sectors of the organization through modeling.

Yet another object of the embodiments herein is to provide a system and method to help an organization to identify specific areas which are capable of mutation and innovation under management focus.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system for measuring and monitoring an innovation intelligence of an enterprise/organization. The system comprises an index engine configured for capturing and aggregating data related to an innovation intelligence from one or more data sources available within the organization. The one or more data sources comprise an excel spread sheet, a data store and a text file. The index engine is further configured for storing the captured/aggregated data in a database. The system also comprises a classification engine configured for classifying the aggregated data into a plurality of measurement indexes. The plurality of measurement indexes is configurable/customizable by the administrators. The plurality of measurement indexes comprises a major/primary index, a plurality of minor/secondary indexes, a plurality of individual innovation indexes, a team innovation index, and a plurality of organizational innovation indexes. The system further comprises an Online Analytical Processing (OLAP) engine configured for performing a multidimensional analysis of the data stored in the database. The multidimensional analysis comprises performing complex calculations, a trend analysis and a data modeling. The system still further comprises an innovation measurement module configured for computing an innovation quotient for each of the identified primary and secondary indexes modeled as part of the classification engine. The innovation quotient represents the organizations ability in managing each of the indexes. The system still further comprises a criteria engine configured for enabling the administrators to specify one or more criteria for evaluating the calculated innovation quotient. The one or more criteria comprise at least one primary or secondary index. The one or more criteria's are either pre-specified by the administrators or customized based on an organization requirement. The system still further comprises a management console communicatively coupled with the server. The management console is configured for on-boarding a plurality of users to the system. The management console is further configured to enable the administrators to configure an access right for an individual user. The system still further comprises a dashboard communicatively coupled with the server. The dashboard is configured for visually representing a graphical, analytical and textual information about the measured innovation quotient for the organization to the plurality of users.

According to an embodiment herein, a default page of the dashboard is displayed to the user according to the access rights configured for the user by the administrators and based on the organizational hierarchy index.

According to an embodiment herein, the classification engine is further configured for generating a comprehensive map of the individual indexes and relationship amongst the indexes for calculating the innovation intelligence quotient of the organization.

According to an embodiment herein, the dashboard is further configured for displaying a graphical information based on the one or more criteria specified in the criteria engine, for identification, retrieval and processing of the related data based on the plurality of measurement indexes customized by the administrators.

According to an embodiment herein, the index engine is further configured for retrieving a first part of data related to primary indexes and a second part of data related to secondary indexes and the index engine is further configured for processing the first and second parts in a cascading form.

According to an embodiment herein, the administrators are enabled to configure and present a questionnaire to the user for collecting an information regarding the innovation.

According to an embodiment herein, the system is further configured for updating and customizing the primary and secondary indexes in the form of the dashboard based on the results of the questionnaire.

According to an embodiment herein, a method for measuring and monitoring innovation intelligence of an enterprise/organization is provided. The method comprises the steps of capturing and aggregating data related to innovation intelligence from one or more data sources available within the organization using an index engine. The captured/aggregated data is stored into a database. The aggregated data is classified into a plurality of measurement indexes using a classification engine. The plurality of measurement indexes comprise major/primary indexes, minor/secondary indexes, individual innovation indexes, team innovation indexes, and organizational innovation indexes. An innovation quotient is computed for each of the identified primary and secondary indexes modeled as part of the classification engine. The administrators are enabled to specify one or more criterias for the evaluation of the computed innovation quotient. The graphical, analytical and textual information about the computed innovation quotient for the organization is visually presented to the plurality of users using a dashboard.

According to an embodiment herein, the method further comprises performing a multidimensional analysis of the data stored in the database using an Online Analytical Processing (OLAP) engine.

According to an embodiment herein, the step of performing multidimensional analysis further comprises performing complex calculations, trend analysis and data modeling.

According to an embodiment herein, the method further comprises the step of on-boarding a plurality of users to the system using a management console. The management console is configured for enabling the administrators to configure the access rights for an individual user.

According to an embodiment herein, the method further comprises the step of displaying a default page of the dashboard to the user according to the access rights configured for the user by the administrators and based on the organizational hierarchy index.

According to an embodiment herein, the method further comprises the step of generating a comprehensive map of the individual indexes and relationship amongst the indexes for determining innovation intelligence quotient of the organization.

According to an embodiment herein, the method further comprises the step of displaying graphical information to the user based on the one or more criteria specified in the criteria engine, for identification, retrieval and processing of related data based on the plurality of measurement indexes customized by the administrators.

According to an embodiment herein, the method further comprises the step of retrieving a first part of data related to primary indexes and a second part of data related to secondary indexes and for processing of first and second parts in a cascading form.

According to an embodiment herein, the method further comprises the step of configuring and presenting a questionnaire to the user for collecting information regarding the innovation.

According to an embodiment herein, the method further comprises the step of updating and customizing the primary and secondary indexes in the form of the dashboard based on the results of the questionnaire.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for measuring and monitoring innovation intelligence of an enterprise, according to an embodiment herein.

FIG. 2 illustrates a schematic diagram indicating a basic classification of innovation Intelligence, according to an embodiment herein.

FIG. 3 illustrates a schematic diagram indicating the minor classifications of opportunities, according to an embodiment herein.

FIG. 4 illustrates a schematic diagram indicating the minor classifications of challenges, according to an embodiment herein.

FIG. 5 illustrates a schematic diagram indicating the minor classifications of competitive advantage, according to an embodiment herein.

FIG. 6 illustrates a schematic chart representing an innovation intelligence measurement, according to an embodiment herein.

FIG. 7 illustrates a flowchart explaining a process for measurement of innovation intelligence, according to an embodiment herein.

FIG. 8 illustrates a block diagram of an innovation intelligence monitoring system, according to an embodiment herein.

FIG. 9 illustrates a flowchart explaining a method for implementation and supervising innovation intelligence, according to an embodiment herein.

FIG. 10 illustrates an innovation intelligence dashboard that is displayed based on the dimensions of challenge management, according to an embodiment herein.

Although the specific features of the present invention are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a system for measuring and monitoring an innovation intelligence of an enterprise/organization. The system comprises an index engine configured for capturing and aggregating data related to an innovation intelligence from one or more data sources available within the organization. The one or more data sources comprise an excel spread sheet, a data store and a text file. The index engine is further configured for storing the captured/aggregated data in a database. The system also comprises a classification engine configured for classifying the aggregated data into a plurality of measurement indexes. The plurality of measurement indexes is configurable/customizable by the administrators. The plurality of measurement indexes comprises a major/primary index, a plurality of minor/secondary indexes, a plurality of individual innovation indexes, a team innovation index, and a plurality of organizational innovation indexes. The system further comprises an Online Analytical Processing (OLAP) engine configured for performing a multidimensional analysis of the data stored in the database. The multidimensional analysis comprises performing complex calculations, a trend analysis and a data modeling. The system still further comprises an innovation measurement module configured for computing an innovation quotient for each of the identified primary and secondary indexes modeled as part of the classification engine. The innovation quotient represents the organizations ability in managing each of the indexes. The system still further comprises a criteria engine configured for enabling the administrators to specify one or more criteria for evaluating the calculated innovation quotient. The one or more criteria comprise at least one primary or secondary index. The one or more criteria's are either pre-specified by the administrators or customized based on an organization requirement. The system still further comprises a management console communicatively coupled with the server. The management console is configured for on-boarding a plurality of users to the system. The management console is further configured to enable the administrators to configure an access right for an individual user. The system still further comprises a dashboard communicatively coupled with the server. The dashboard is configured for visually representing a graphical, analytical and textual information about the measured innovation quotient for the organization to the plurality of users.

According to an embodiment herein, a default page of the dashboard is displayed to the user according to the access rights configured for the user by the administrators and based on the organizational hierarchy index.

According to an embodiment herein, the classification engine is further configured for generating a comprehensive map of the individual indexes and relationship amongst the indexes for calculating the innovation intelligence quotient of the organization.

According to an embodiment herein, the dashboard is further configured for displaying a graphical information based on the one or more criteria specified in the criteria engine, for identification, retrieval and processing of the related data based on the plurality of measurement indexes customized by the administrators.

According to an embodiment herein, the index engine is further configured for retrieving a first part of data related to primary indexes and a second part of data related to secondary indexes and the index engine is further configured for processing the first and second parts in a cascading form.

According to an embodiment herein, the administrators are enabled to configure and present a questionnaire to the user for collecting an information regarding the innovation.

According to an embodiment herein, the system is further configured for updating and customizing the primary and secondary indexes in the form of the dashboard based on the results of the questionnaire.

According to an embodiment herein, a method for measuring and monitoring innovation intelligence of an enterprise/organization is provided. The method comprises the steps of capturing and aggregating data related to innovation intelligence from one or more data sources available within the organization using an index engine. The captured/aggregated data is stored into a database. The aggregated data is classified into a plurality of measurement indexes using a classification engine. The plurality of measurement indexes comprise major/primary indexes, minor/secondary indexes, individual innovation indexes, team innovation indexes, and organizational innovation indexes. An innovation quotient is computed for each of the identified primary and secondary indexes modeled as part of the classification engine. The administrators are enabled to specify one or more criterias for the evaluation of the computed innovation quotient. The graphical, analytical and textual information about the computed innovation quotient for the organization is visually presented to the plurality of users using a dashboard.

According to an embodiment herein, the method further comprises performing a multidimensional analysis of the data stored in the database using an Online Analytical Processing (OLAP) engine.

According to an embodiment herein, the step of performing multidimensional analysis further comprises performing complex calculations, trend analysis and data modeling.

According to an embodiment herein, the method further comprises the step of on-boarding a plurality of users to the system using a management console. The management console is configured for enabling the administrators to configure the access rights for an individual user.

According to an embodiment herein, the method further comprises the step of displaying a default page of the dashboard to the user according to the access rights configured for the user by the administrators and based on the organizational hierarchy index.

According to an embodiment herein, the method further comprises the step of generating a comprehensive map of the individual indexes and relationship amongst the indexes for determining innovation intelligence quotient of the organization.

According to an embodiment herein, the method further comprises the step of displaying graphical information to the user based on the one or more criteria specified in the criteria engine, for identification, retrieval and processing of related data based on the plurality of measurement indexes customized by the administrators.

According to an embodiment herein, the method further comprises the step of retrieving a first part of data related to primary indexes and a second part of data related to secondary indexes and for processing of first and second parts in a cascading form.

According to an embodiment herein, the method further comprises the step of configuring and presenting a questionnaire to the user for collecting information regarding the innovation.

According to an embodiment herein, the method further comprises the step of updating and customizing the primary and secondary indexes in the form of the dashboard based on the results of the questionnaire.

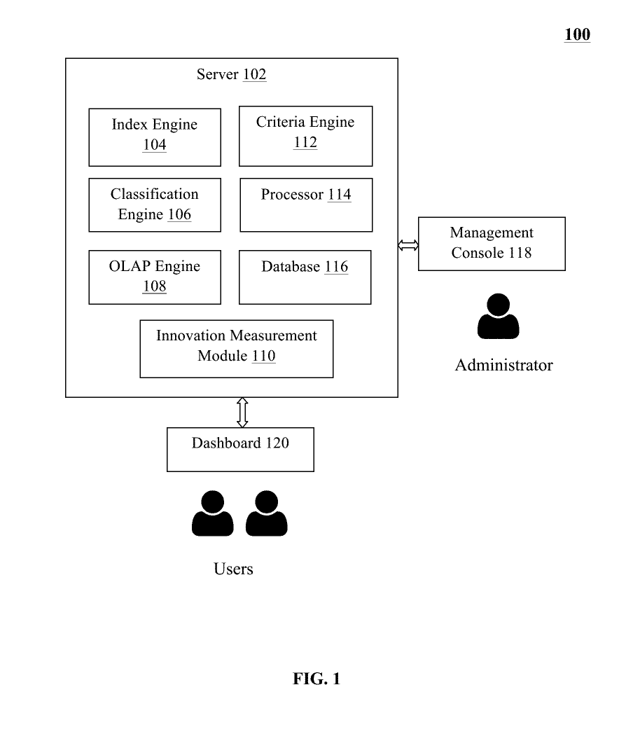

FIG. 1 illustrates a block diagram of a system for measuring and monitoring innovation intelligence of an enterprise, according to an embodiment herein. The system comprises the server 102, the management console 118 and the dashboard 120. The server further comprises the index engine 104, the classification engine 106, the OLAP engine 108, the innovation measurement module 110, the criteria engine 112, the processor 114 and the database 116.

According to an embodiment herein, the index engine 104 is configured for capturing and aggregating data related to innovation intelligence from one or more data sources available within the organization. The one or more data sources comprise excel spread sheet, a data store and a text file. The index engine 104 is further configured for storing the captured/aggregated data in a database. The index engine 104 is further configured for retrieving a first part of data related to primary indexes and a second part of data related to secondary indexes and for processing of first and second parts in a cascading form.

According to an embodiment herein, the classification engine 106 is configured for classifying the aggregated data into a plurality of measurement indexes. The plurality of measurement index is configurable/customizable by the administrators. The plurality of measurement indexes comprises major/primary indexes, minor/secondary indexes, individual innovation indexes, team innovation indexes, and organizational innovation indexes. the classification engine 106 is further configured for generating a comprehensive map of the individual indexes and relationship amongst the indexes for determining innovation intelligence quotient of the organization.

In one example embodiment, the plurality of measurement indexes in the organization comprises classification of innovation into three aspects of individual, team, and organizational innovation. Additionally other classifications classify innovation as subjective at the organizational type level. One of them is a classification based on the cube model. The information dashboard strengthens organizational innovation through combination of these classifications and develops a logical model of relationship of indexes in aspects of challenge management, competitive advantage and opportunities in organization, diversity dimensions, dynamic self-organization, and reactivity.

According to an embodiment herein, the OLAP engine 108 is configured for performing a multidimensional analysis of the data stored in the database 116. The multidimensional analysis comprises performing complex calculations, trend analysis and data modeling. OLAP systems are designed to provide quick answers to queries and analytical queries on multi-dimensional data including capabilities such as observing reports (without limitations), complex analytical calculations and prediction scenario planning. OLAP enables end users to perform data analysis in various ways thus increasing the user's perception of data for decision making. Each user is ranked based on the defined indicators, the type of capabilities and position that the decision or organization has. The analytical representation of the data is based on the specific information of each user. Information is dynamically designed and presented for each employer with user training (customizable by each user) by integrating these categories and creating a logical model of the association of indicators in the form of dashboards.

According to an embodiment herein, the innovation measurement module 110 is configured for computing an innovation quotient for each of the identified primary and secondary indexes modeled as part of the classification engine 106. The innovation quotient represents the organizations ability in managing each index.

According to an embodiment herein, the criteria engine 112 is configured for enabling the administrators to specify one or more criteria's for the evaluation of the determined innovation quotient. The one or more criteria comprises at least one primary or secondary index. The one or more criteria's are either pre-specified by the administrators or are customized based on organization need.

According to an embodiment herein, the management console 118 is configured for on-boarding a plurality of users to the system. The management console 118 is further configured for enabling the administrators to configure access rights for individual user.

According to an embodiment herein, the dashboard 120 is configured for visually representing the graphical, analytical and textual information about the measured innovation quotient for the organization to the plurality of users. A default page of the dashboard 120 is displayed to the user according to the access rights configured for the user by the administrators and based on the organizational hierarchy index. The dashboard 120 is further configured for displaying graphical information based on the one or more criteria's specified in the criteria engine and for identification, retrieval and processing of related data based on the plurality of measurement indexes customized by the administrators.

According to an embodiment herein, the administrators are enabled to configure and present a questionnaire to the user for collecting information regarding the innovation. The system is further configured for updating and customizing the primary and secondary indexes in the form of the dashboard 120 based on the results of the questionnaire.

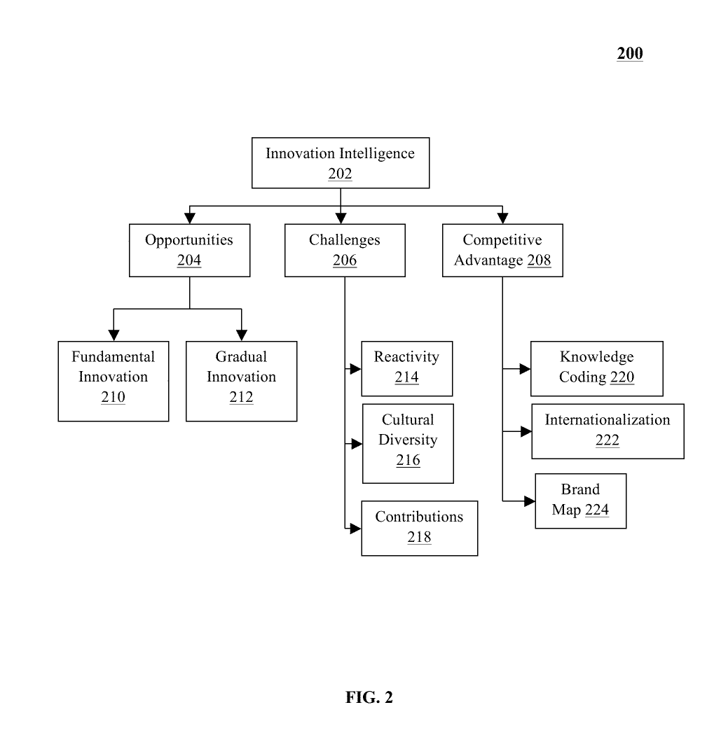

FIG. 2 illustrates a schematic diagram depicting basic classification of innovation Intelligence, according to an embodiment herein. Innovation Intelligence 202 is basically categorized into three categories that are opportunities 204, challenges 206, and competitive advantage 208. This helps promoting a moderate organization to a good one, a good one to an excellent one, and an excellent one to achieve exceptional levels of challenge management, competitive advantage, and opportunity utilization. In the overall view, opportunities 204 include fundamental (transformational) innovation 210 and gradual innovation 212 which emerges from identification of market need or unused resources and capacities and gives a new combination of contrasting ideas for production of new and useful solutions. This creates a space that individuals are more tended and able to share and combine their talents and emotions. Challenges 206 include reactivity 214, cultural diversity 216, and contributions 218, and cause highlighting differences and formation of idea portfolio in the organization. Competitive advantage 208 includes knowledge coding 220, internalization 222, and brand map 224, and it means the ability to test and refine preliminary runs through quick follow-up and feedback. This represents an attractive combination of scientific method and artistic process.

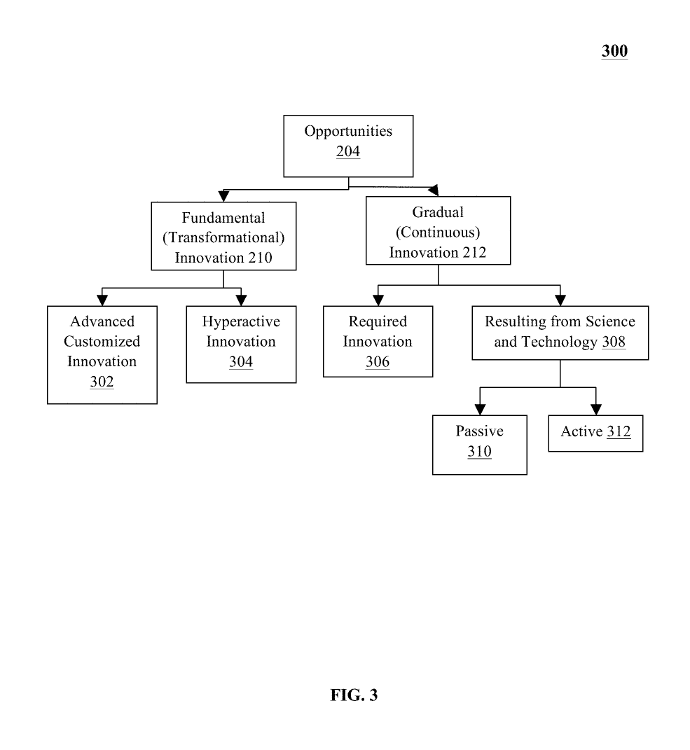

FIG. 3 illustrates a schematic diagram depicting minor classifications of opportunities, according to an embodiment herein. Fundamental (transformational) innovation 210 contains capabilities for advanced customized innovation 302 and hyperactive innovation 304. This shows management's will and organizational capabilities to provide innovative solutions. Gradual innovation 212 includes necessary innovation 306, innovation resulting from science and technology 308, passive innovation 310, and active innovation 312, which represents team capabilities for formation of multi-disciplinary teams and the emergence of competencies and individual capabilities. In addition, gradual innovation also refers to the size of staff achievements and convergence in multi-disciplinary teams. In one example embodiment, gradual innovation includes scientific and operational communications and strength of communication. In another example embodiment, fundamental innovation 210 represents integrated leadership and perception of shared values in organization. Measurement of fundamental innovation 210 indicates organization orientation in innovative competitions for changing the game and providing new game in the organizational area. Gradual innovation 212 includes the organization's experience and expertise in solving the complicated problems and adapting processes and policies for ongoing improvement.

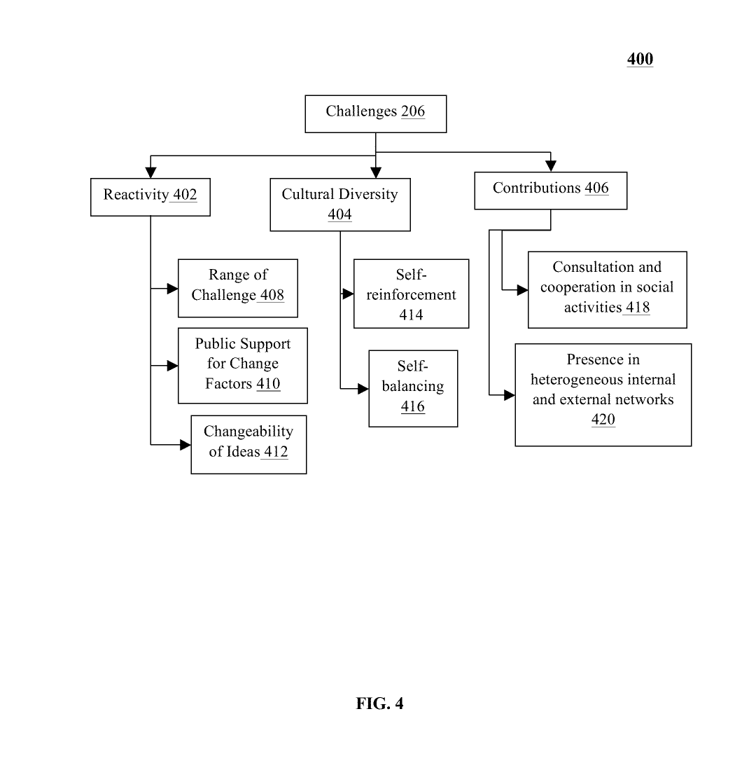

FIG. 4 illustrates a schematic diagram depicting minor classifications of challenges, according to an embodiment herein. The classification comprises reactivity 402, cultural diversity 404 and contributions 406. Reactivity 402 further includes challenge ranges 408, general support for change factors 410 and changeability of ideas 412. This represents the direction of organization to excellence and exit from the existing frameworks. This includes the economic value of new activities and previous successful projects of the organization, discovery of unmet customer needs and the amount of credit allocated for new works in the organization. Cultural diversity 404 further comprises self-reinforcement 414 and self-balancing 416. Contribution 406 further comprises consultation and cooperation in social activities 418 and presence in heterogeneous internal and external networks 420.

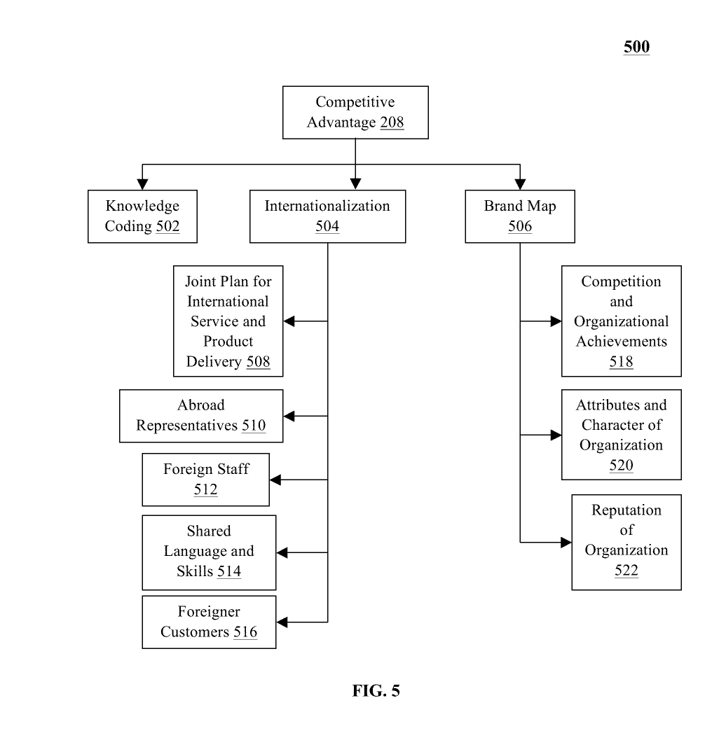

FIG. 5 illustrates a schematic diagram depicting minor classifications of competitive advantage, according to an embodiment herein. The classification comprises knowledge encoding 502, internationalization 504 and brand map 506. Knowledge encoding 502 includes representation of tacit knowledge, implicit knowledge, explicit knowledge management of the organization and the success rate in its dissemination. Internationalization 504 contains joint programs of international service and product delivery 508, abroad representatives 510, foreigner staff 512, shared language and skills 514 and foreigner customers 516. It indicates utilization of new technology, new joint companies, staff exchange, and participation in international programs. Brand map 506 includes history and achievements of organization 518, attributes and character of organization 520, reputation of organization 522, which represents social effects of organization's activities during the activity, responsibility and investment in social and charity activities, fame and reputation and national and international evaluation. Innovation intelligence (opportunities 204, challenges 206, and competitive advantage 208) is related to some criteria. Each criterion is a measurable index which is measured by sum of data or other methods. In one example embodiment this criterion is financial or non-financial and is measured by value of each financial indexes. Non-financial index is the index that is measured by time, voting result, number, or any other non-financial index. The criterion is related to other indexes for determining innovation intelligence level.

According to an embodiment herein, an example sample list of criteria for innovation intelligence in opportunities for gradual invention comprises internal motivation, bottom-up organizational culture, average to high challenge range etc. For fundamental innovation the list comprises internal motivation, top-down organizational culture, high challenge range and the like.

According to an embodiment herein, an example sample list of criteria for innovation intelligence in challenges for reactivity comprises reactivity, economic value of new activities in employed unit, amount of credit allocated for new tasks, methods of discovering unmet customer needs, existing plans for challenging current methods, existing plans for refreshment in employed unit etc. For contributions the list comprise presence of different learning models in employed unit, presence of periods of prediction and prioritization of new technologies development, utilization of teamwork in employed unit. For cultural diversity the list comprises identification of ideas and new products in employed unit, change in working processes with new technology development, allocating time for acquire information and new knowledge in working area and the like.

According to an embodiment herein, an example sample list of criteria for innovation intelligence in competitive advantage for knowledge coding comprises number of initial demands for projects, number of publications in international journals and books, success percent in acquiring projects versus the whole, number of international publications of each faculty member, number of running research projects, number of branch companies, number of papers presented at conferences, number of patents, number of books printed/written by faculty, number of international awards received etc. For brand map the list comprises faculty Members, average age of faculty members, number of employees (research, administrative), average evaluation of faculty members in view of students, percent of faculty members compared to total number of employees, percent of trained faculty members in institute, percent of faculty members compared to the number of students, the number of hours allocated to faculty members for seminars, percent of employees compared to total number of students, number of newly recruited individuals etc. For internationalization the list comprises number of international experienced students, percent of lecturers invited to learning programs, percent of international students, number of faculty members participating in conferences, number of international faculty members, number of concluded agreements, number of cooperating countries and the like.

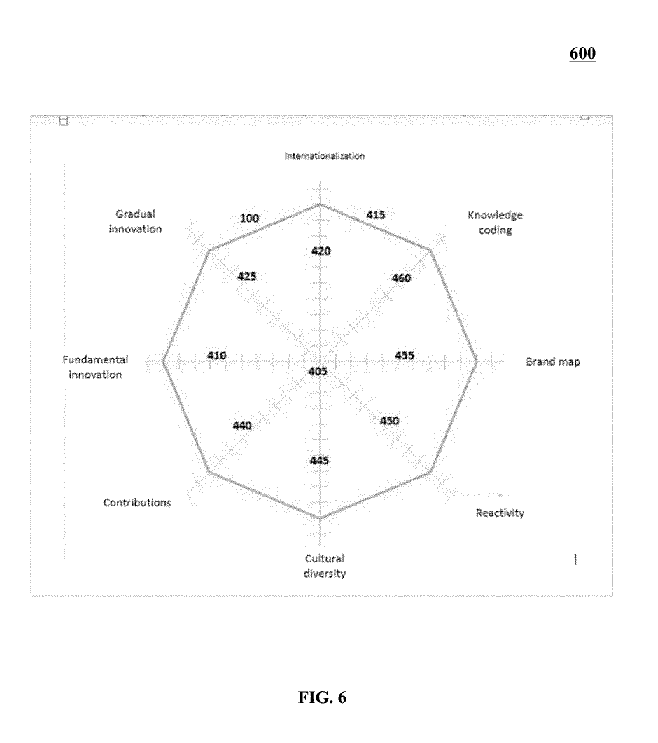

FIG. 6 illustrates example radar representing innovation intelligence measurement, according to an embodiment herein. With respect to FIG. 6, all points between 405 to 460 are drawn on the scale. The monitored innovation intelligence and integrated growth level in the main indexes are compared. Appropriateness of index growth in the shared axes is analyzed to estimate innovative performance's value and impact of each sector on it.

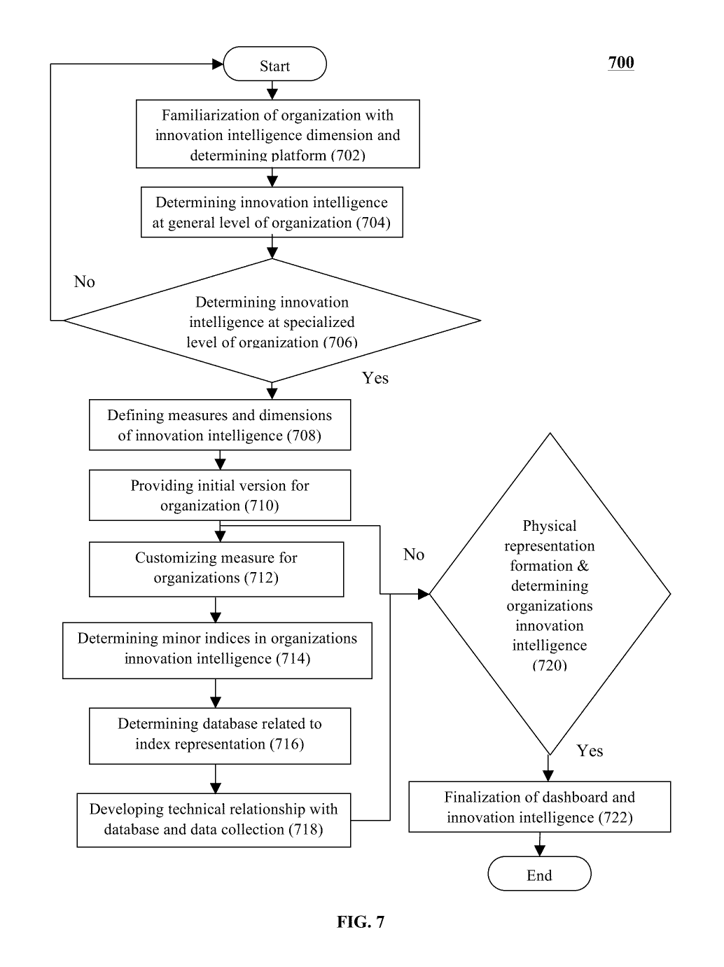

FIG. 7 illustrates a flowchart depicting a process for measurement of innovation intelligence, according to an embodiment herein. With respect to FIG. 7, proprieties of the organization are determined by its familiarization with dimensions of innovation intelligence (702). For example, considering type of organization's activities, which is in the service or product delivery area, the priorities are variable. General level of the innovation intelligence in organization is specified at step 704. At step 706, it is decided that if determining innovation intelligence at general and specific level of the organization is needed or not. Then at step 708, the measures and dimensions of innovation intelligence for the organization are defined. At step 710, the key criteria for providing primary version of specific innovation intelligence to the customer are carried out. At step 712, the measure is specialized for the customer and includes measurement of innovation capacities and capabilities in all stakeholders related to the organization. According to step 714, minor innovation indexes are specified. At step 716, the databases related to indexes are specified, and at step 716, technical relationship with database and data collection is designed. At step 718, the way of presenting decision-making about data analysis presentation and determination of organization's innovation intelligence is specified. On approval in step 720, the final version of innovation intelligence dashboard is provided (722).

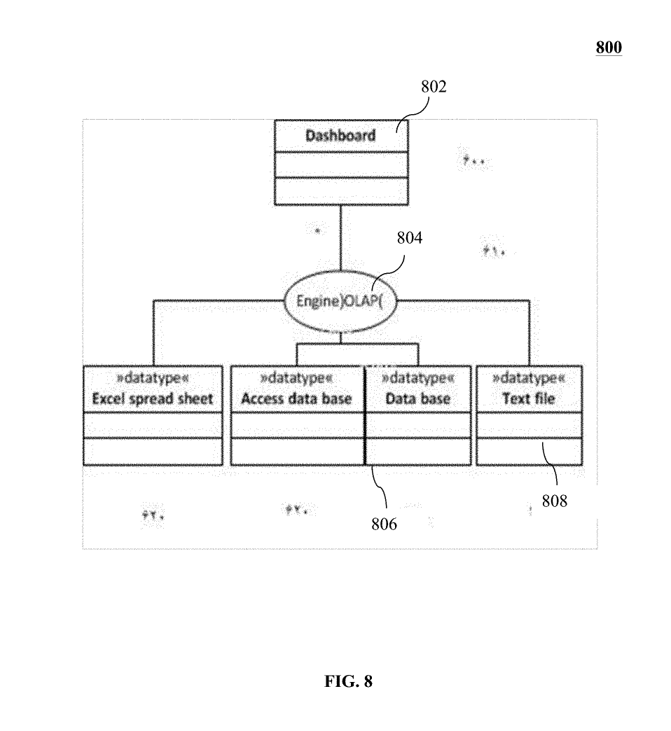

FIG. 8 illustrates an innovation intelligence monitoring system, according to an embodiment herein. The system comprises the dashboard 802 of innovation intelligence, engine 804, the database 806 and practical applications. Innovation intelligence dashboard is connected to engine 804 as the checker and the detector and is able to receive information from the databases and the text and excel 808 files. This dashboard includes input 808 and output module 802. The output module 802 is capable of displaying information to the user based on the user level and user-defined metrics from the dashboard 802. The dashboard 802 is customizable to the user's needs. The engine 804 has the ability to integrate and store data in dense forms and is retrieved and processed in the form of dashboard 802. The dashboard 802 and engine 804 through the OLAP mechanism, provide access to integration of all information in 808 into databases, and allow their encryption and usage.

According to an embodiment herein, each record or row of information lists in the database 808 records field for an entity. In text files (Word, HTML), a text separator such as spacing, comma or “ . . . ” fields are used. The relations to each entity are specified so that data is retrieved and analyzed when read. Also, in order to read the database types (SQL Server, Oracle, MySQL), a profile view or view in a database is used. The output of 808 to 802 is presented in a variety of different comparative charts and based on the map. The custom indicators of each organization are displayed in a dynamic and flexible environment allowing for the creation of different levels of innovation intelligence.

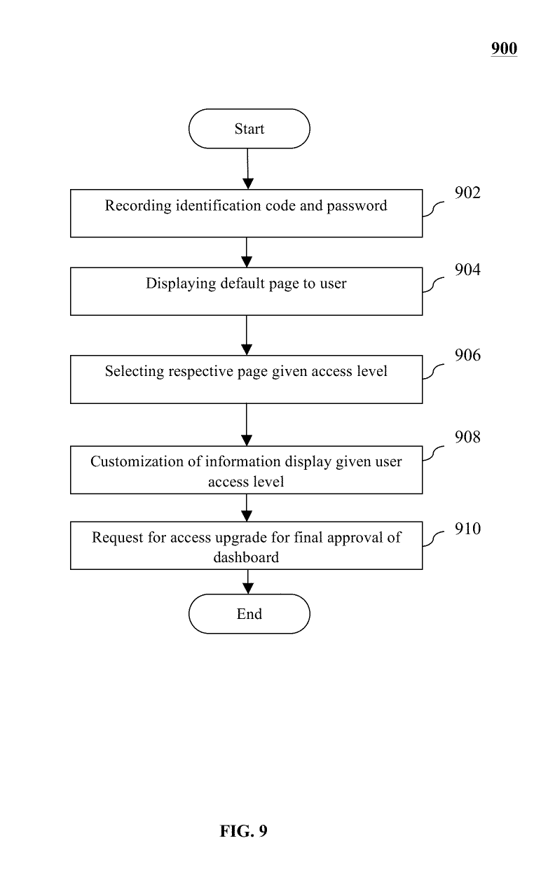

FIG. 9 illustrates a flowchart depicting a method for implementation and supervising innovation intelligence, according to an embodiment herein. At step 902, the organization initiates innovation intelligence implementation, and accordingly user identification and control is provided. Then, at step 904, the default page of dashboard is displayed to the user considering the access level defined for the user and based on the organizational hierarchy. In one example embodiment, the senior managers have access to all indexes and information, while junior administrative managers have access to some information. At step 906, selection of respective page given access level that is appropriate to the user's activity in the organizational area is done. Step 908 provides customization of information display according to the user access level in the activity area. In step 910, the set of defaults of criteria and innovation intelligence data are displayed to the user and the user confirms the dashboard pages by default, so that the access change and final approval is done.

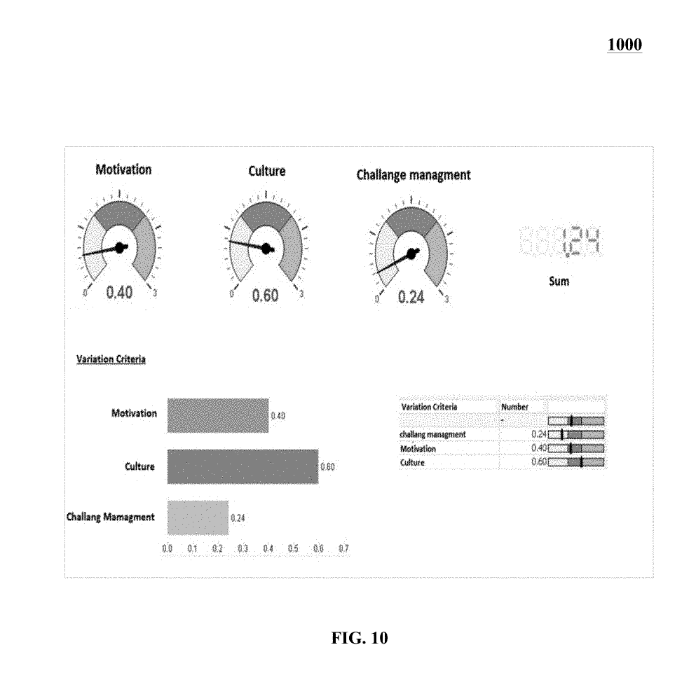

FIG. 10 illustrates an example of an innovation intelligence dashboard that is displayed based on the dimensions of challenge management, according to an embodiment herein. With respect to FIG. 10, the number obtained is from computing the main indexes, including the code 1,1,2 and 2,1,3 representing the organization's ability to manage challenges, and in the domain of culture, the number obtained from the computation of main indicators is 2,3,1 and 2,3,2 representing the organization's ability to develop an innovation culture. In the area of motivation, the number derived from the main indicators is 2,1,4 and 2,1,5 representing the organization's ability to motivate.

According to an embodiment herein, each user is ranked based on the defined indicators and the type of capabilities and position of the decision or organization. The analytical representation of the data is based on the specific information of each user. By integrating these categories and creating a logical model of the association of indicators in the form of dashboards, information is designed and presented for each employer with user training dynamically and customizable by each user.

According to an embodiment herein, each criterion is a measurable indicator evaluated by a combination of data or other methods. An example list of the main criteria for innovation intelligence comprises the economic value of new activities in the employment unit, methods to uncover the unmet needs of customers, existing programs to challenge current methods, existing programs for creating job satisfaction, identifying new ideas and products in the employment unit, changes in working processes with the development of new technology and the like. Also, in different organizations and teams, according to the results of the questionnaire, there are possibilities of changing between the main and secondary indicators and customizing it in the form of a dashboard. The dynamic structure of the system considered for innovation intelligence allows different changes and displacements without violating the invention area and range.

Therefore, the system helps organizations to enhance the brand status in a balanced manner through knowledge coding, internationalization of services and products, development of practiced innovation activities, monitoring factors affecting motivation of staffs, cultural values strengthening innovation, and management of challenges. The other advantages offered by the system include calculation of organizational status change, classification of innovations, improvement of overall performances of financial value creation and basic key organizational capabilities. The innovation intelligence dashboard provided by the system allows users to identify the best innovation performances and accordingly develop new measurement criteria and is able to promote other sectors of the organization by modeling it. Thus, the minor sectors, which are capable of mutation and innovation in case of management focus are specified and put on the development path.

Thus, the information dashboard strengthens organizational innovation through development of a logical model of relationship of indexes in aspects of challenge management, competitive advantage and opportunities in organization, diversity dimensions, dynamic self-organization, and reactivity. The system strengthens activities in the innovation lab by using the competitive advantage for dynamic competition in the organization, the possibility of calculating the organizational change, classification of innovations, improving the overall performance of financial value and key capabilities of the organization. The innovation intelligence dashboard allows the user to identify the best innovation performance and to build new benchmarking measures that enhance other parts of the organization through benchmarking. Accordingly, the sub-sectors that, if managed centrally, have the ability to jump and innovate are set in the path of development and growth.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be the to fall there between.

What is claimed is:

1. A system for measuring and monitoring innovation intelligence of an enterprise/organization, the system comprising:
an index engine provided in a server and run on a hardware processor, and wherein the index engine is configured for capturing and aggregating data related to an innovation intelligence from one or more data sources available within an organization, and wherein the one or more data sources comprise an excel spread sheet, a data store and a text file, and wherein the index engine is further configured for storing the captured/aggregated data in a database;
a classification engine provided in a server and run on a hardware processor, and wherein the classification engine is configured for classifying the aggregated data into a plurality of measurement indexes, and wherein the plurality of measurement indexes are configurable/customizable by the administrators, and wherein the plurality of measurement indexes comprise major/primary indexes, minor/secondary indexes, individual innovation indexes, team innovation indexes, and organizational innovation indexes;
an Online Analytical Processing (OLAP) engine provided in a server and run on a hardware processor, and wherein the OLAP engine is configured for performing a multidimensional analysis of the data stored in the database, and wherein the multidimensional analysis comprises performing complex calculations, trend analysis and data modeling;
an innovation measurement module provided in a server and run on a hardware processor, and wherein the innovation measurement module is configured for computing an innovation quotient for each of the identified primary and secondary indexes modeled as part of the classification engine, and wherein the innovation quotient represents the organizations ability in managing each of the index;
a criteria engine provided in a server and run on a hardware processor, and wherein the criteria engine is configured for enabling the administrators to specify one or more criteria for evaluating the computed innovation quotient, and wherein the one or more criteria comprises at least one primary or secondary index, and wherein the one or more criteria's are either pre-specified by the administrators or customized based on an organization requirement;
a management console communicatively coupled with the server, and wherein the management console is configured for on-boarding a plurality of users to the system, and wherein the management console is further configured for enabling the administrators to configure access rights for individual user; and
a dashboard communicatively coupled with the server, and wherein the dashboard is configured for visually representing the graphical, analytical and textual information about the measured innovation quotient for the organization to the plurality of users.

2. The system according to claim 1, wherein the dashboard is configured to display a default page to the user according to the access rights configured for the user by the administrators and based on the organizational hierarchy index.

3. The system according to claim 1, wherein the classification engine is further configured for generating a comprehensive map of the individual indexes and relationship amongst the indexes for computing the innovation intelligence quotient of the organization.

4. The system according to claim 1, wherein the dashboard is further configured for displaying graphical information based on the one or more criteria specified in the criteria engine and for identification, retrieval and processing of related data based on the plurality of measurement indexes customized by the administrators.

5. The system according to claim 1, wherein the index engine is further configured for retrieving a first part of data related to primary indexes and a second part of data related to secondary indexes and for processing the first part and the second part in a cascading form.

6. The system according to claim 1, wherein the administrators are enabled to configure and present a questionnaire to the user for collecting information regarding the innovation.

7. The system according to claim 6, wherein the system is further configured for updating and customizing the primary and secondary indexes in the form of the dashboard based on the results of the questionnaire.

8. A computer implemented method comprising instructions stored on a non-transitory computer readable storage medium and run on a computing device provided with a hardware processor and memory for measuring and monitoring innovation intelligence of an enterprise/organization, the method comprising the steps of:
capturing and aggregating data related to innovation intelligence from one or more data sources available within the organization using an index engine;
storing the captured/aggregated data into a database;
classifying the aggregated data into a plurality of measurement indexes using a classification engine, and wherein the plurality of measurement indexes comprise major/primary indexes, minor/secondary indexes, individual innovation indexes, team innovation indexes, and organizational innovation indexes;
computing an innovation quotient for each of the identified primary and secondary indexes modeled as part of the classification engine;
enabling the administrators to specify one or more criteria's for the evaluation of the computed innovation quotient; and
visually representing the graphical, analytical and textual information about the measured innovation quotient for the organization to the plurality of users using a dashboard.

9. The method according to claim 8, wherein the method further comprises performing a multidimensional analysis of the data stored in the database using an OLAP engine.

10. The method according to claim 9, wherein the step of performing multidimensional analysis further comprises performing complex calculations, trend analysis and data modeling.

11. The method according to claim 8, wherein the method further comprises the step of on-boarding a plurality of users to the system using a management console, and wherein the management console is configured for enabling the administrators to configure access rights for individual user.

12. The method according to claim 8, wherein the method further comprises the step of displaying a default page of the dashboard to the user according to the access rights configured for the user by the administrators and based on the organizational hierarchy index.

13. The method according to claim 8, wherein the method further comprises the step of generating a comprehensive map of the individual indexes and relationship amongst the indexes for determining innovation intelligence quotient of the organization.

14. The method according to claim 8, wherein the method further comprises the step of displaying graphical information to the user based on the one or more criteria's specified in the criteria engine and for identification, retrieval and processing of related data based on the plurality of measurement indexes customized by the administrators.

15. The method according to claim 8, wherein the method further comprises the step of retrieving a first part of data related to primary indexes and a second part of data related to secondary indexes and for processing of first and second parts in a cascading form.

16. The method according to claim 8, wherein the method further comprises the step of configuring and presenting a questionnaire to the user for collecting information regarding the innovation.

17. The method according to claim 16, wherein the method further comprises the step of updating and customizing the primary and secondary indexes in the form of the dashboard based on the results of the questionnaire.
